(19) United States
(12) Patent Application Publication
(10) Pub. No.: US 2019/0392979 A1
(43) Pub. Date: Dec. 26, 2019

(54) ELECTROMAGNETIC DEVICE INCLUDING IRON CORE SUPPORTING STRUCTURE

(71) Applicant: Fanuc Corporation, Yamanashi (JP)

(72) Inventor: Shouhei Kobayashi, Minamitsuru-gun (JP)

(73) Assignee: Fanuc Corporation, Yamanashi (JP)

(21) Appl. No.: 16/436,050

(22) Filed: Jun. 10, 2019

(30) Foreign Application Priority Data
Jun. 20, 2018 (JP) 2018-117302

(51) Int. Cl. H01F 27/26; H01F 27/28

(52) U.S. Cl. CPC H01F 27/263; H01F 27/28

(57) ABSTRACT

An electromagnetic device includes: an outer circumferential iron core; at least three iron core leg portions; and coils, wherein each of the iron core leg portions is disposed in such a way that one end portion of the coil is supported by the outer circumferential iron core in a cantilevered manner and magnetically bound to the outer circumferential iron core while the other end portion is magnetically bound to the other end portions of the other iron core leg portions, and includes a base including an opening for housing a portion of the coils and holding the outer circumferential iron core at a position of a predetermined height from the mounting surface and a supporting structure that is disposed in contact with the other end portions of the iron core leg portions and that supports the iron core leg portions at a predetermined height from the mounting surface.

### BACKGROUND OF THE INVENTION

### 1. Field of the Invention

The present invention relates to an electromagnetic device, and more particularly to an electromagnetic device including a supporting structure.

### 2. Description of the Related Art

In the past, there have been reported reactor devices in which a reactor including a core and a coil is attached to a mounting base portion (for example, Japanese Unexamined Patent Publication (Kokai) No. 2006-351675). The reactor disclosed in Japanese Unexamined Patent Publication (Kokai) No. 2006-351675 is attached to a supporting base portion of a case. The core consists of a pair of core segments disposed facing against each other across a gap made of an air layer, and the supporting base portion is provided with positioning groove portions for positioning each of the core segments.

### SUMMARY OF INVENTION

In conventional reactors, when a weight of a core segment is heavy, there is a possibility that the core segment may sink toward a mounting base portion. In this case, there is a problem in that change in the size of the gap between the pair of core segments brings about variation in the magnitude of iron loss.

An electromagnetic device according to one example of the present disclosure includes: an outer circumferential iron core; at least three iron core leg portions arranged on an inner face side of the outer circumferential iron core at intervals in a circumferential direction; and coils wound on each of the at least three iron core leg portions, wherein each of the at least three iron core leg portions is disposed in such a way that one end portion thereof in a winding axis direction of the coil is supported by the outer circumferential iron core in a cantilevered manner and magnetically bound to the outer circumferential iron core while the other end portion thereof in the winding axis direction is magnetically bound to the other end portions of the other iron core leg portions of the at least three iron core leg portions, and includes a base including an opening for housing a portion of the coils and holding the outer circumferential iron core at a position of a predetermined height from a mounting surface and a supporting structure that is disposed in contact with the other end portions of the at least three iron core leg portions and that supports the iron core leg portions of the at least three iron core leg portions at a predetermined height from the mounting surface.

The electromagnetic device according to one example of the present disclosure prevents a core central portion from sinking and may suppress iron loss since no gap is formed between core joint surfaces.

### BRIEF DESCRIPTION OF THE DRAWINGS

FIG. 1 is a perspective view of an electromagnetic device according to an embodiment 1;

FIG. 2 is a perspective view for describing an assembly process of the electromagnetic device according to the embodiment 1;

FIG. 3 is a plan view of an outer circumferential iron core and iron core leg portions of the electromagnetic device according to the embodiment 1;

FIG. 4 is a side view of the electromagnetic device according to the embodiment 1;

FIG. 5 is a plan view of the electromagnetic device according to the embodiment 1;

FIG. 6 is a plan view of an electromagnetic device according to another example of the embodiment 1;

FIG. 7 is a perspective view of an electromagnetic device according to a variation of the embodiment 1;

FIG. 8 is a perspective view for describing an assembly process of the electromagnetic device according to the variation of the embodiment 1;

FIG. 9 is a side view of the electromagnetic device according to the variation of the embodiment 1;

FIG. 10 is a perspective view of an electromagnetic device according to an embodiment 2;

FIG. 11 is a plan view of the electromagnetic device according to the embodiment 2; and

FIG. 12 is a side view of the electromagnetic device according to the embodiment 2.

### DETAILED DESCRIPTION

Electromagnetic devices according to the present invention will be described below with reference to the drawings. It should be noted that a technical scope of the present invention is not limited to the embodiments and extends to the inventions recited in the claims and equivalents thereof. In the drawings below, similar members are denoted by similar reference numerals. To facilitate understanding, these drawings use different scales as appropriate.

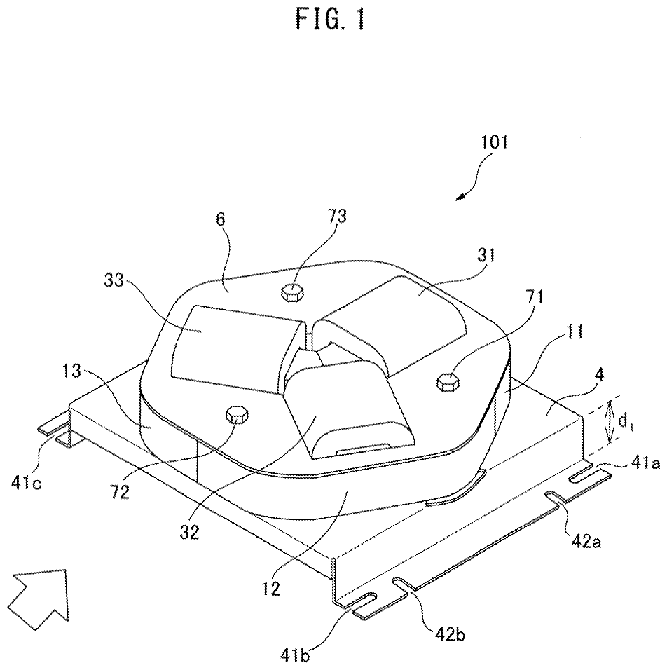

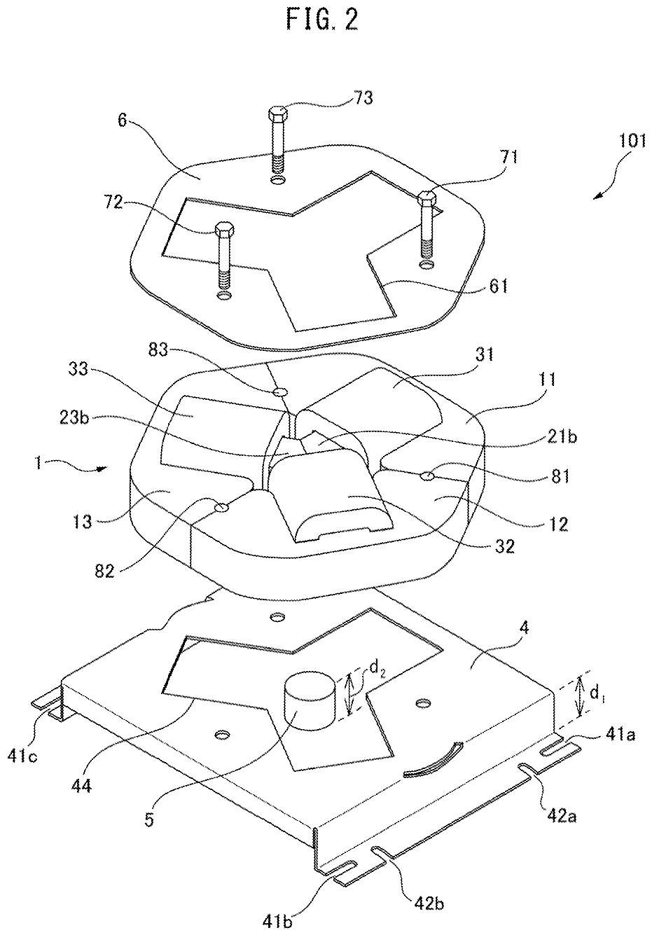

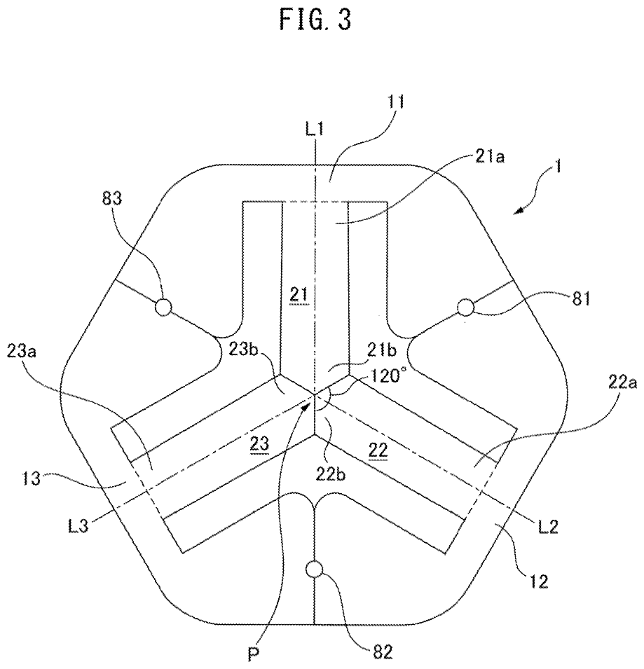

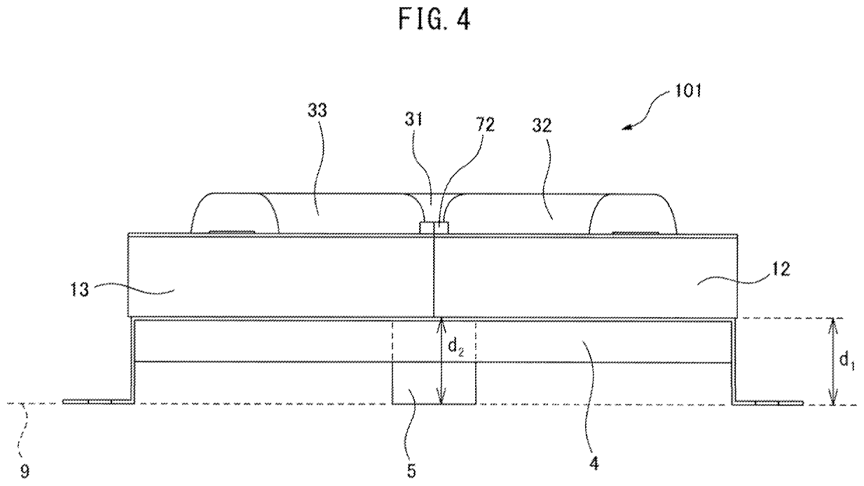

First, an electromagnetic device according to an embodiment 1 will be described. The following description are made using a transformer such as a three-phase transformer as an example of electromagnetic devices. FIG. 1 presents a perspective view of the electromagnetic device according to the embodiment 1. FIG. 2 presents a perspective view for describing an assembly process of the electromagnetic device according to the embodiment 1. FIG. 3 presents a plan view of an outer circumferential iron core and iron core leg portions of the electromagnetic device according to the embodiment 1. FIG. 4 presents a side view of the electromagnetic device according to the embodiment 1.

A three-phase transformer 101 includes an outer circumferential iron core 1, at least three iron core leg portions (21, 22, 23), coils (31, 32, 33), a base 4, and a supporting structure 5.

The outer circumferential iron core 1 may consist of a plurality of outer circumferential iron core segments (11, 12, 13). As illustrated in FIGS. 1 to 3, the outer circumferential iron core 1 may consist of three outer circumferential iron core segments (11, 12, 13). FIG. 1 and FIG. 2 illustrate an example in which the outer shape of the outer circumferential iron core 1 is hexagonal; however, it may have a shape other than that such as a circular shape.

The at least three iron core leg portions (21, 22, 23) are arranged on an inner face side of the outer circumferential iron core 1 at intervals in a circumferential direction. The outer circumferential iron core 1 and the iron core leg portions (21, 22, 23) may be configured by stacking a plurality of iron sheets, carbon steel sheets, or electrical steel sheets, or they may be formed of a magnetic material such as ferrite or a dust core.

The coils (31, 32, 33) are respectively wound on the at least three iron core leg portions (21, 22, 23). The coils (31, 32, 33) may include at least one of a primary coil and a secondary coil. For the coils, a conductor such as a rectangular wire or a circular wire formed of an electrically conducting material including copper, aluminum, magnesium, or the like may be used.

In each of the at least three iron core leg portions (21, 22, 23), one end portion thereof (21a, 22a, 23a) in a winding axis (L1, L2, L3) direction of the coils (31, 32, 33) is supported by the outer circumferential iron core 1 in a cantilevered manner and magnetically bound to the outer circumferential iron core 1. The winding axis referred here is the central axis around which the coil is wound. In the present example, the coils (31, 32, 33) are wound around the iron core leg portions (21, 22, 23); therefore, the winding axes (L1, L2, L3) of the coils (31, 32, 33) respectively coincide with the central axes of the iron core leg portions (21, 22, 23). The example illustrated in FIG. 3 is an example in which the three iron core leg portions (21, 22, 23) are respectively integrated with the three outer circumferential iron core segments (11, 12, 13) constituting the outer circumferential iron core 1. By integrating each of the three outer circumferential iron core segments (11, 12, 13) with the corresponding three iron core leg portions (21, 22, 23), the assembly process of the three-phase transformer 101 may be simplified. However, the configuration is not limited to such an example, and the iron core leg portions (21, 22, 23) and the outer circumferential iron core segments (11, 12, 13) may be formed separately.

In the outer circumferential iron core 1, through-holes (81, 82, 83) are provided to insert bolts for fixing the outer circumferential iron core 1 to the base 4. For example, as illustrated in FIG. 3, a through-hole 81 may be formed between the outer circumferential iron core segments 11 and 12 constituting the outer circumferential iron core 1, a through-hole 82 may be formed between the outer circumferential iron core segments 12 and 13, and a through-hole 83 may be formed between the outer circumferential iron core segments 13 and 11.

In addition, each of the at least three iron core leg portions (21, 22, 23) is disposed in such a way that the other end portion thereof (for example, 21b) in the winding axis (for example, L1) direction of the coil is magnetically bound to the other end portions (22b, 23b) of the other iron core leg portions (22, 23) of the at least three iron core leg portions (21, 22, 23).

The three iron core leg portions (21, 22, 23) have the same size and shape, and they are disposed inside the outer circumferential iron core 1 at equal intervals in a circumferential direction around the center P of the outer circumferential iron core 1. In this case, the winding axes (L1, L2, L3) of the three coils (31, 32, 33) intersect with each other at the center P in such a way that the adjacent two winding axes (L1 and L2, L2 and L3, L3 and L1) make an angle of 120°. In addition, end portions of the three iron core leg portions (21, 22, 23) on the center P side extending along the winding axes (L1, L2, L3) have a shape converging toward the center P, and each end portion forms an angle of approximately 120°.

The base 4 includes an opening 44 for housing a portion of the coils (31, 32, 33). In addition, the base 4 holds the outer circumferential iron core 1 at a position of a predetermined height d₁ from a mounting surface 9. It is preferably configured that the coils (31, 32, 33) are not in contact with the mounting surface 9 in a state in which the base 4 is holding the outer circumferential iron core 1.

The base 4 is a box-shaped member provided separately from the outer circumferential iron core 1. The base 4 may be fixed to the mounting surface 9 by a fastener member (not illustrated).

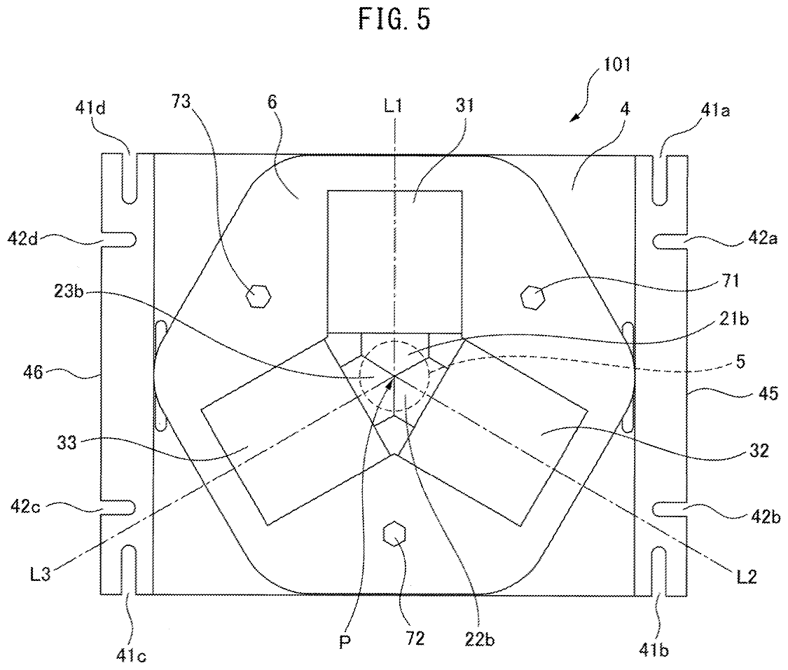

FIG. 5 presents a plan view of the electromagnetic device according to the embodiment 1. In the base 4, a plurality of notches for inserting a shaft of a fastener member is provided in the vicinity of two sides 45 and 46 disposed at positions facing against each other. In the vicinity of the side 45, notches (41a, 41b, 42a, 42b) are provided. The notches 41a and 41b have a cutout portion extending in a direction parallel to the side 45. In contrast, the notches 42a and 42b have a cutout portion extending in a direction perpendicular to the side 45. Similarly, in the vicinity of the side 46, notches (41c, 41d, 42c, 42d) are provided. The notches 41c and 41d have a cutout portion extending in a direction parallel to the side 46. In contrast, the notches 42c and 42d have a cutout portion extending in a direction perpendicular to the side 46.

The notches (41a to 41d, 42a to 42d) may also be used in temporarily fixing the base 4 to the mounting surface 9. As an example, a case where a three-phase transformer 101, which is an electromagnetic device, is mounted on the mounting surface 9 set up upright in a vertical direction will be described. By providing fastener members in the mounting surface 9 in advance and inserting the fastener members into the notches (42a, 42b) in a state in which the side 45 of the base 4 is facing downward, the base 4 can be temporarily fixed to the mounting surface 9. In addition, by providing fastener members in the mounting surface 9 in advance and inserting the fastener members into the notches (41b, 41c) in a state in which a side perpendicular to the side 45 of the base 4 is facing downward, the base 4 can be temporarily fixed to the mounting surface 9. In this manner, irrespective of the orientation of the base 4, the base may be temporarily fixed to the mounting surface 9 set up upright in a vertical direction; thus, a man-hour for mounting the base may be reduced. The supporting structure 5 is disposed in contact with the other end portions (21b, 22b, 23b) of the three iron core leg portions (21, 22, 23), and supports the at least three iron core leg portions (21, 22, 23) at a position d₂ of a predetermined height from the mounting surface 9. The predetermined height from the mounting surface 9 at which the base 4 holds the outer circumferential iron core 1 and the predetermined height from the mounting surface 9 at which the supporting structure 5 supports the at least three iron core leg portions (21, 22, 23) are preferably equal. In other words, the base 4 supports the outer circumferential iron core 1 at the predetermined height d₁ from the mounting surface 9, and the predetermined height d₂ is preferably the same as the predetermined height d₁ (d₂=d₁). In this case, the winding axes (L1, L2, L3) of the coils (31, 32, 33) are preferably horizontal to the mounting surface 9. In this manner, it is possible to keep the central axes of the plurality of outer circumferential iron core segments (11, 12, 13) horizontal to the mounting surface 9 and to prevent the three iron core leg portions (21, 22, 23) corresponding to a core central portion from sinking; thus, iron loss may be suppressed since no gap is formed between joint surfaces of the outer circumferential iron core segments (11, 12, 13).

The base 4 and the supporting structure 5 may be formed of a non-magnetic material such as stainless steel, aluminum, or brass or a carbon material.

As illustrated in FIG. 2, by placing the outer circumferential iron core 1 on the base 4, disposing a cover 6 on the outer circumferential iron core 1, and fastening these with bolts (71, 72, 73), the outer circumferential iron core 1 may be fixed to the base 4. An opening 61 is provided in the cover 6 and contact between the coils (31, 32, 33) and the cover 6 may be avoided.

In the base 4 and the cover 6, holes are provided at positions corresponding to those of the through-holes (81, 82, 83) provided in the outer circumferential iron core segments (11, 12, 13), and bolts (71, 72, 73) may be inserted therethrough.

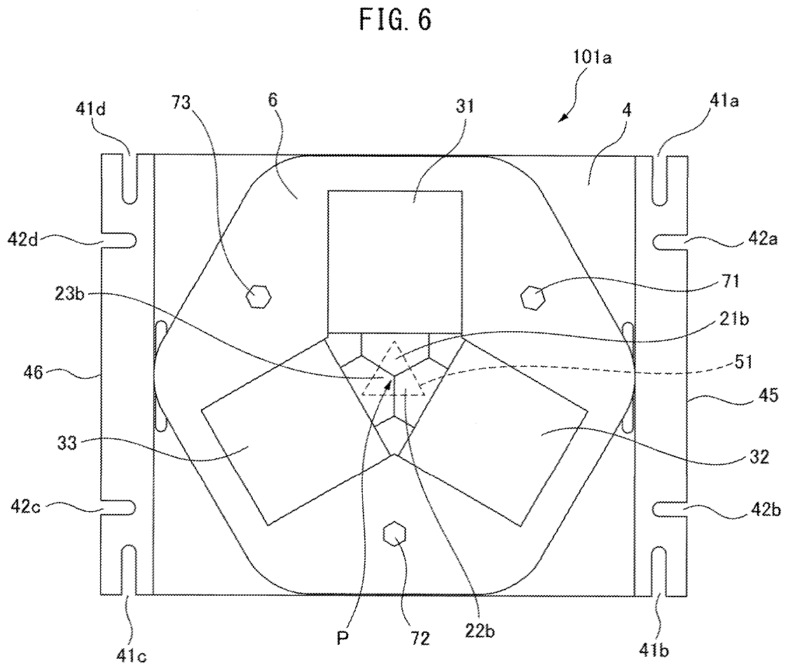

FIG. 6 presents a plan view of a three-phase transformer 101a, which is an electromagnetic device according to another example of the embodiment 1. The supporting structure 51 is disposed between a vicinity of the other end portions (21b, 22b, 23b) of the three iron core leg portions (21, 22, 23) and the mounting surface 9, and supports a portion of the at least three iron core leg portions (21, 22, 23) at a position d₂ of a predetermined height from the mounting surface 9. As described above, it is assumed that the base 4 supports the outer circumferential iron core 1 at the predetermined height di from the mounting surface 9, and that the predetermined height d₂ is the same as the predetermined height d₁ (d₂=d₁). In this case, the winding axes (not illustrated) of the coils (31, 32, 33) are preferably horizontal to the mounting surface 9. In this manner, it is possible to keep the central axes of the plurality of outer circumferential iron core segments horizontal to the mounting surface 9 and to prevent the three iron core leg portions corresponding to the core central portion from sinking; thus, iron loss may be suppressed since no gap is formed between joint surfaces of the outer circumferential iron core segments (11, 12, 13). FIG. 6 illustrates an example in which the supporting structure 51 has a triangular prismatic shape. However, the shape is not limited to such an example, and the supporting structure 51 may have a polygonal columnar shape such as a quadrangular prismatic shape.

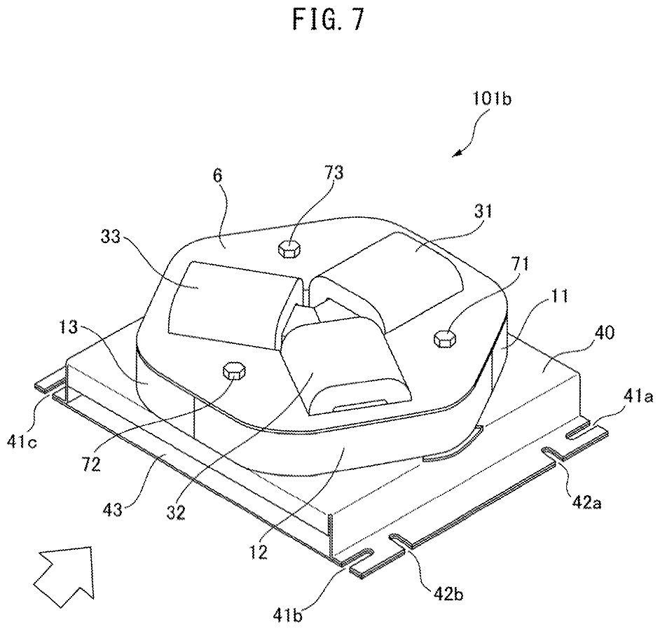

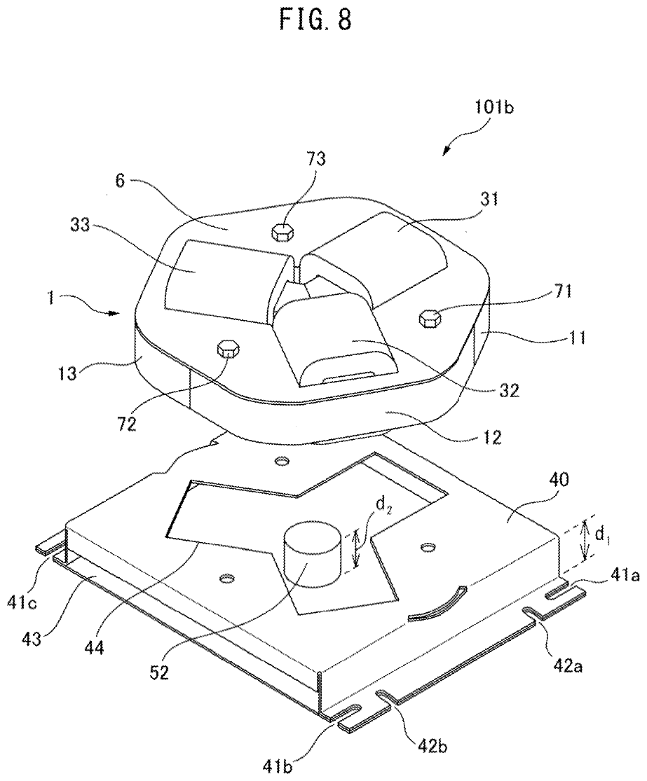

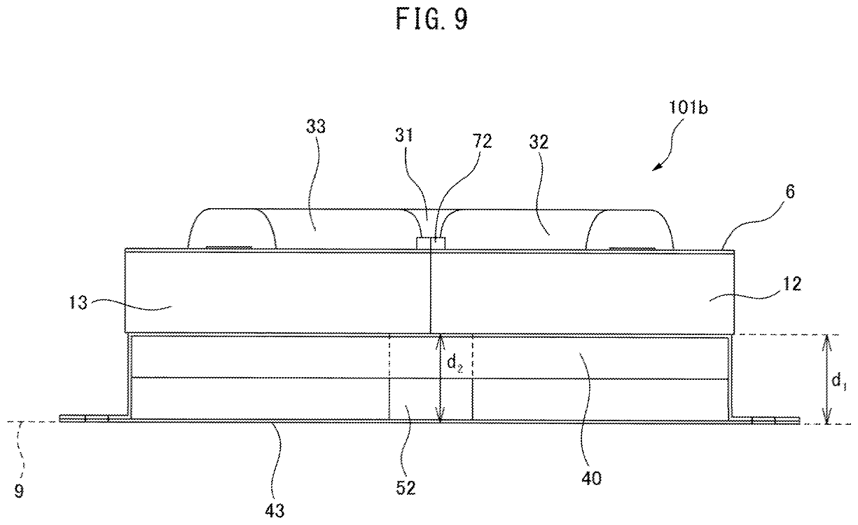

Then, an electromagnetic device according to a variation of the embodiment 1 will be described. FIG. 7 presents a perspective view of the electromagnetic device according to the variation of the embodiment 1. FIG. 8 presents a perspective view for describing an assembly process of the electromagnetic device according to the variation of the embodiment 1. FIG. 9 presents a side view of the electromagnetic device according to the variation of the embodiment 1, viewed from an arrow direction in FIG. 7.

In a three-phase transformer 101b, which is the electromagnetic device according to the variation of the embodiment 1, a bottom portion 43 is provided in a base 40, and a supporting structure 52 is provided on the bottom portion 43. The supporting structure 52 supports a portion of the at least three iron core leg portions at a position d₂ of a predetermined height from the mounting surface 9. It is assumed that the base 40 supports the outer circumferential iron core 1 at the predetermined height d₁ from the mounting surface 9, and that the predetermined height d₂ is the same as the predetermined height d₁ (d₂=d₁). In this case, the winding axes (not illustrated) of the coils (31, 32, 33) are preferably horizontal to the mounting surface 9. In this manner, it is possible to keep the central axes of the plurality of outer circumferential iron core segments horizontal to the mounting surface 9 and to prevent the three iron core leg portions corresponding to a core central portion from sinking; thus, iron loss may be suppressed since no gap is formed between joint surfaces of the outer circumferential iron core segments (11, 12, 13). FIG. 8 illustrates an example in which the supporting structure 52 has a circular cylindrical shape. However, the shape is not limited to such an example, and the supporting structure 52 may have a polygonal columnar shape such as a triangular prismatic shape or a quadrangular prismatic shape. The supporting structure 52 and the base 40 may be integrally formed. By employing such a configuration, the supporting structure and the iron core leg portions may be easily positioned.

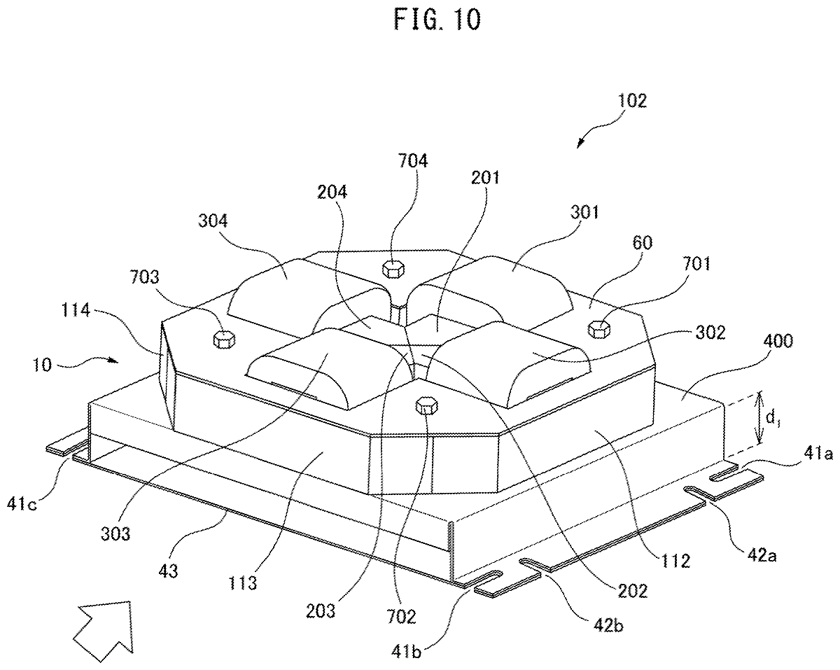

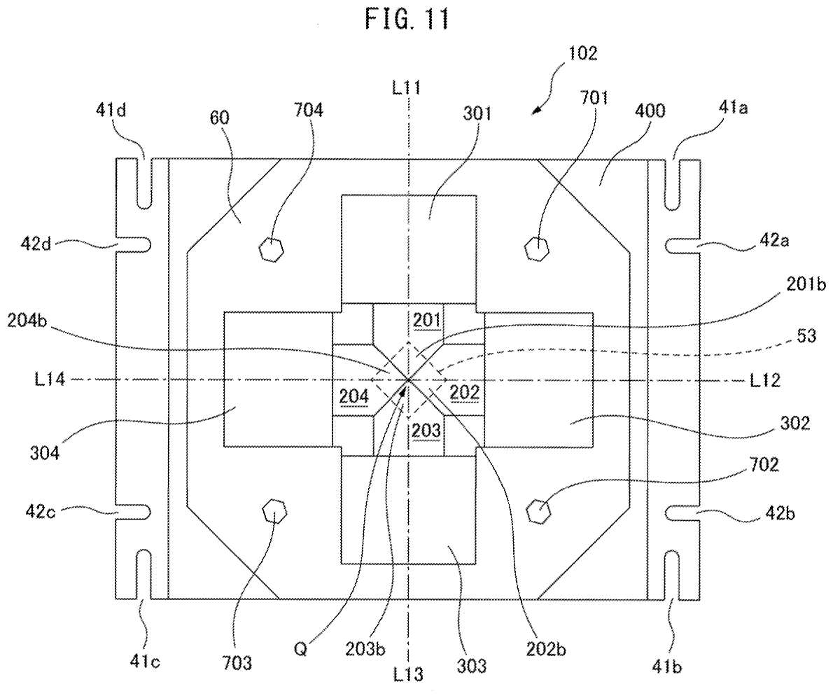

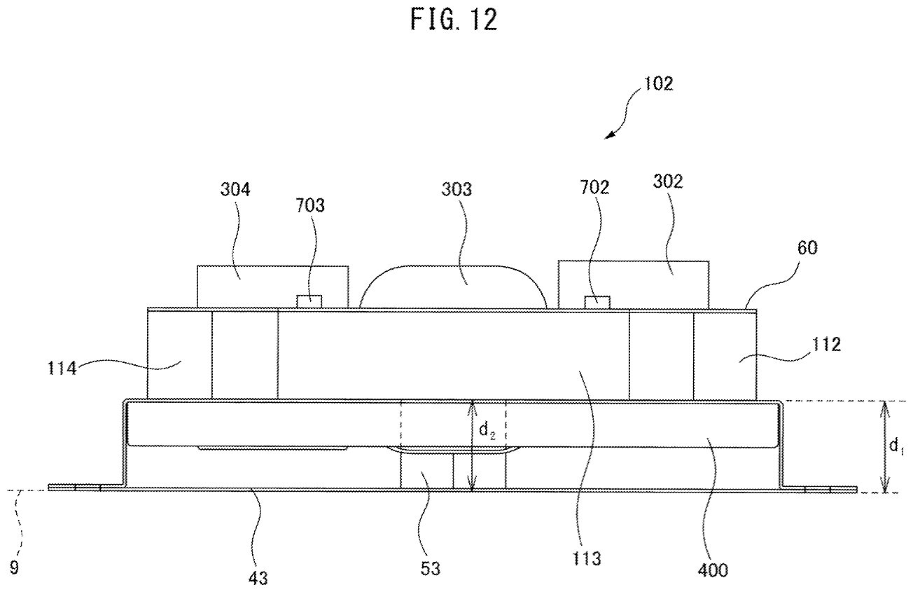

Then, an electromagnetic device according to an embodiment 2 will be described. FIG. 10 presents a perspective view of the electromagnetic device according to the embodiment 2. FIG. 11 presents a plan view of the electromagnetic device according to the embodiment 2. FIG. 12 presents a side view of the electromagnetic device according to the embodiment 2, viewed from an arrow direction in FIG. 10. A single-phase transformer 102, which is the electromagnetic device according to the embodiment 2, differs from the three-phase transformer 101, which is the electromagnetic device according to the embodiment 1, in that the number of at least three iron core leg portions (201, 202, 203, 204) is an even number, equal to or greater than four. Other configurations of the electromagnetic device according to the embodiment 2 are similar to those of the electromagnetic device according to the embodiment 1; therefore, detailed description thereof will be omitted.

FIGS. 10 to 12 illustrate an example in which each number of outer circumferential iron core segments, the iron core leg portions, and coils are four; however, the configuration is not limited to such an example. The outer circumferential iron core 10 consists of four outer circumferential iron core segments (111 (not illustrated), 112, 113, 114).

The four iron core leg portions (201, 202, 203, 204) are arranged on an inner face side of the outer circumferential iron core 10 at intervals in a circumferential direction.

The coils (301, 302, 303, 304) are respectively wound on the four iron core leg portions (201, 202, 203, 204).

In each of the four iron core leg portions (201, 202, 203, 204), one end portion thereof in a winding axis (L11, L12, L13, L14) direction of the coils (301, 302, 303, 304) is magnetically bound to the plurality of outer circumferential iron core segments (111, 112, 113, 114).

In addition, the other end portions (201b, 202b, 203b, 204b) of the four iron core leg portions (201, 202, 203, 204) in the winding axis (L11, L12, L13, L14) direction are disposed in such a way that they are magnetically bound to the other end portions of the other iron core leg portions of the four iron core leg portions (201, 202, 203, 204).

The four iron core leg portions (201, 202, 203, 204) have the same size and shape, and they are disposed inside the outer circumferential iron core 10 at equal intervals in a circumferential direction around the center Q of the outer circumferential iron core 10. In this case, the winding axes (L11, L12, L13, L14) of the four coils (301, 302, 303, 304) intersect with each other at the center Q in such a way that the adjacent two winding axes (L11 and L12, L12 and L13, L13 and L14, L14 and L11) make an angle of 90°. In addition, end portions on the center Q side of the four iron core leg portions (201, 202, 203, 204) extending along the winding axes (L11, L12, L13, L14) have a shape converging toward the center Q, and each end portion forms an angle of approximately 90°.

The base 400 includes an opening (not illustrated) for housing a portion of the coils (301, 302, 303, 304). The base 400 holds the outer circumferential iron core 1 at a position of a predetermined height di from the mounting surface 9. It is preferably configured that the coils (301, 302, 303, 304) are not in contact with the mounting surface 9 in a state in which the base 400 is holding the outer circumferential iron core 1.

As illustrated in FIG. 10, by placing the outer circumferential iron core 10 on the base 400, disposing a cover 60 on the outer circumferential iron core 10, and fastening these with bolts (701, 702, 703, 704), the outer circumferential iron core 10 may be fixed to the base 400. An opening is provided in the cover 60 and contact between the coils (301, 302, 303, 304) and the cover 60 may be avoided.

The supporting structure 53 is disposed between a vicinity of the other end portions (201b, 202b, 203b, 204b) and the mounting surface 9, and supports a portion of the four iron core leg portions (201, 202, 203, 204) at a position d₂ of a predetermined height from the mounting surface 9.

FIG. 11 and FIG. 12 illustrate a supporting structure having a quadrangular prismatic shape as an example of the supporting structure 53; however, the shape is not limited to such an example, and the supporting structure 53 may have a polygonal columnar shape other than a circular cylindrical shape, a triangular prismatic shape, or a quadrangular prismatic shape.

It is assumed that the supporting structure 53 supports the four iron core leg portions (201, 202, 203, 204) at the predetermined height d₂ from the mounting surface 9, that the base 400 supports the four outer circumferential iron core segments (111, 112, 113, 114) at the predetermined height di from the mounting surface 9, and that the predetermined height d₂ is the same as the predetermined height d₁ (d₂=d₁). In this case, the winding axes (L11, L12, L13, L14) of the coils (301, 302, 303, 304) are preferably horizontal to the mounting surface 9. In this manner, it is possible to keep the central axes of the four outer circumferential iron core segments (111, 112, 113, 114) horizontal to the mounting surface 9 and to prevent the four iron core leg portions (201, 202, 203, 204) corresponding to the core central portion from sinking; thus, iron loss may be suppressed since no gap is formed between joint surfaces of the outer circumferential iron core segments (111, 112, 113, 114).

In the description above, the examples in which a transformer is used as an electromagnetic device have been described; however, the present invention may be applicable to a reactor.

1. An electromagnetic device, comprising:
an outer circumferential iron core;
at least three iron core leg portions arranged on an inner face side of the outer circumferential iron core at intervals in a circumferential direction; and
coils wound on each of the at least three iron core leg portions,
wherein each of the at least three iron core leg portions is disposed in such a way that one end portion thereof in a winding axis direction of the coil is supported by the outer circumferential iron core in a cantilevered manner and magnetically bound to the outer circumference portion iron core while the other end portion thereof in the winding axis direction is magnetically bound to the other end portions of the other iron core leg portions of the at least three iron core leg portions, and comprising:
a base including an opening for housing a portion of the coils and holding the outer circumferential iron core at a position of a predetermined height from a mounting surface; and
a supporting structure disposed in contact with the other end portions of the at least three iron core leg portions and supporting the at least three iron core leg portions at a predetermined height from the mounting surface.

2. The electromagnetic device according to claim 1,
wherein the predetermined height from the mounting surface at which the base holds the outer circumferential iron core and the predetermined height from the mounting surface at which the supporting structure supports the at least three iron core leg portions are equal.

3. The electromagnetic device according to claim 1,
wherein the supporting structure and the base are integrally formed.

4. The electromagnetic device according to claim 1,
wherein the number of the at least three iron core leg portions is a multiple number of three.

5. The electromagnetic device according to claim 1,
wherein the number of the at least three iron core leg portions is an even number, equal to or greater than four.

6. The electromagnetic device according to claim 1,
wherein the coils include at least one of a primary coil and a secondary coil.
